(19) United States
(12) Patent Application Publication
(10) Pub. No.: US 2025/0070188 A1
(43) Pub. Date: Feb. 27, 2025

(54) POLYMER BASED CURRENT COLLECTOR

(71) Applicant: Sakuu Corporation, San Jose, CA (US)

(72) Inventors: Stephen Rudisill, San Jose, CA (US); Erik Littau, Los Altos Hills, CA (US); Karl Littau, Los Altos Hills, CA (US); Lizett Acosta, San Jose, CA (US); Nojan Aliahmad, San Jose, CA (US); Ali Kahn, San Jose, CA (US); Parinaz Esbah, San Jose, CA (US)

(73) Assignee: Sakuu Corporation, San Jose, CA (US)

(21) Appl. No.: 18/793,409

(22) Filed: Aug. 2, 2024

Related U.S. Application Data
(60) Provisional application No. 63/534,469, filed on Aug. 24, 2023.

(51) Int. Cl. H01M 4/66; H01M 10/0525

(52) U.S. Cl. CPC H01M 4/667; H01M 4/668; H01M 10/0525

(57) ABSTRACT

A battery cell with a polymer based current collector is disclosed. The battery cell includes a battery electrode and a conductive polymer based current collector located on the battery electrode comprised of a conductive polymer layer. The polymer is conductive in the thickness direction between an outer surface of the polymer based current collector and the battery electrode during normal battery operation of the battery cell. The polymer can be an inherently conductive polymer or a polymer composite formed from an insulating polymer material and conductive particles. The conductive polymer based current collector is configured to become less conductive at least in the thickness direction when at least one of heated beyond a melting point associated with the polymer based current collector or stretched beyond a yield point of the conductive polymer based current collector.

### TECHNICAL FIELD

The present disclosure pertains to improved secondary/rechargeable battery cells, battery cells in bipolar configuration in particular using polymer based current collectors (e.g., carbon-loaded polymer current collectors).

### BACKGROUND

The development and commercialization of lithium-ion and lithium-metal batteries has been fraught with safety concerns, due to the high flammability of electrolyte solutions and high reactivity of lithium species, especially metallic lithium. Current collectors for these battery cells are typically made from metals, for example, aluminum for the cathode and copper for the anode. These metals are selected not only for their compatibility with anode and cathode materials, but also their high electronic conductivity, which remains stable over a wide range of environments and conditions. Therefore, if an electronic short occurs within a battery with metallic current collectors (e.g. through dendrite formation or another mechanism), the cell's “circuit” will remain connected until the battery is fully discharged, leading to an incredibly rapid dissipation of energy, often through a small, resistive “wire” in the cell. This can lead to significant heat generation and/or arcing, which can vaporize and/or ignite the electrolyte and other combustible battery components.

In addition to the above-noted issues regarding lithium-ion and lithium-metal batteries, current approaches for recycling of such batteries fall into three primary categories: (1) disassembly (manual delamination); (2) pyrometallurgical separation (e.g., smelting of the metal components); and (3) hydrometallurgical separation (e.g., acid etching to reclaim metal salts). A recent overview of such techniques can be found in the publication https://pubs.acs.org/doi/10.1021/acsenergylett.1c02602, which is hereby incorporated by reference. Among these three techniques, disassembly (e.g., manual delamination) is vastly preferred from an energy usage perspective since the reclaimed materials are largely intact. However, such disassembly can be quite challenging. For example, due to the very small length scales of battery components, the heterogeneous nature of the components, and the intimate contact required, disassembly is incredibly labor-intensive. Thus, while the above-noted metallurgical methods are vastly more energy intensive and yield lower quality recycled materials, they are currently the primary recycling methods used in the industry.

### SUMMARY

A battery cell with a polymer based current collector is disclosed. The battery cell includes a battery electrode and a conductive polymer based current collector located on the battery electrode comprised of a conductive polymer layer. The conductive polymer layer is conductive in the thickness direction between an outer surface of the polymer based current collector and the battery electrode during normal battery operation of the battery cell. The polymer can be an inherently conductive polymer, or a polymer composite formed from an insulating polymer material and conductive particles. The conductive polymer based current collector is configured to become less conductive at least in the thickness direction when at least one of heated beyond a melting point associated with the conductive polymer based current collector or stretched beyond a yield point of the conductive polymer based current collector. In both scenarios, a network of conductive particles is broken to prevent rapid discharge of the battery cell and the thermal events that may result from a rapid discharge.

The polymer based current collector, in one embodiment, includes a conductive polymer layer and at least one additional material layer. The polymer layer is a conductive support layer and the at least one additional material layer includes a conductive permeability prevention layer on the conductive polymer layer configured to at least limit water vapor and oxygen transfer into the battery cell.

The at least one additional material layer may additionally include a conductive inner electrode adhesion layer configured to facilitate adhesion between the battery electrode and the conductive support layer.

The conductive support layer, in various embodiments, is a polymer composite material comprising an insulative polymer material (e.g. a polyolefin such as polyethylene or polypropylene) and conductive particles in an amount sufficient to render the polymer composite material conductive in the thickness direction between the polymer based current collector and the battery electrode during normal battery operation of the battery cell.

The conductive permeability prevention layer, in one embodiment, is a different conductive polymer material (e.g., EVA, PVOH, PVDC, etc.) relative to the conductive support layer between 10 to 50 μm in thickness. The conductive permeability prevention layer, in one embodiment, may also be a thin layer of metal between 20 to 80 nm in thickness.

The conductive polymer layer, in one embodiment, may also be a single layer of polymer with an intrinsically low water vapor and/or oxygen transport rate (e.g. PVDC) and conductive particles in an amount sufficient to render the PVDC conductive in the thickness direction configured to at least limit water vapor and oxygen transfer into the battery cell. For example, in one embodiment, the single layer of polymer has a WVTR and OTR of <5 gm/100 square inch/24 hours and 5 cc/100 square inch/24 hours respectively for a 1 mil thick film.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an operation to adhere a conductive polymer current collector to an electrode, in accordance with one embodiment of the present disclosure.

FIG. 2 shows a flowchart of a method of assembling a battery cell with conductive polymer current collectors for both the anode and cathode, in accordance with one embodiment of the present disclosure.

FIG. 3 shows a battery cell assembled by the method shown in FIG. 2, in accordance with one embodiment of the present disclosure.

FIGS. 4A-4B show a polymer based current collector, in accordance with one or more embodiments of the present disclosure.

FIGS. 5A-5B show a multilayer polymer based current collector, in accordance with one or more embodiments of the present disclosure.

FIGS. 6A-6B show another multilayer polymer based current collector, in accordance with one or more embodiments of the present disclosure.

FIG. 7 shows a graph of the variation of electrical conductivity of a carbon-loaded composite conducting polymer sheet as a function of filler content (e.g., the amount of carbon) added to a polymer that is insulative, in accordance with aspects of the present disclosure.

FIG. 8 shows a graph of the effects of deformation on the electrical conductivity of conductive polymer current collectors as a function of strain, in accordance with aspects of the present disclosure.

FIG. 9 shows a delaminating apparatus to provide controllable delamination of a battery cell constructed with conductive polymer current collectors, in accordance with aspects of the present disclosure.

### DETAILED DESCRIPTION

In the following detailed description, numerous specific details are set forth by way of examples to provide a thorough understanding of the disclosed subject matter. It may become apparent to persons of ordinary skill in the art, though, upon reading this disclosure, that one or more disclosed aspects may be practiced without such details. In addition, description of various example implementations according to this disclosure may include referencing of or to one or more known techniques or operations, and such referencing can be at relatively high-level, to avoid obscuring of various concepts, aspects and features thereof with details not particular to and not necessary for fully understanding the present disclosure.

The present disclosure provides conductive polymer current collectors that become more insulating when exposed to temperature excursions or mechanical distortion. These features serve to open the cell's circuit (e.g., break the current flow path through the cell), thereby preventing further electrochemical reaction during periods of large sudden increase in current flow through the battery cell (e.g., during a short circuit or a foreign body penetrating the cell). Construction of such a battery cell (e.g. a bipolar cell) requires unique scaling approaches, which are also disclosed herein, and electrical isolation between anodes and cathodes of the cell is critical to prevent shorting. This constitutes a key enabling technology for producing safe, high-quality, rechargeable battery cells in accordance with the present disclosure. The behavior identified here can also help improve battery cell safety associated with nail penetration, crush, or puncture because the polymer films used for current collectors herein also become insulating when mechanically deformed. A nail or other object penetrating or deforming the battery cell will deform the polymer current collectors around the impact point, which will cause their resistance to increase significantly, thus reducing or stopping the current flow from the short circuit.

Increased energy density remains a consistent demand and constant challenge, shorts can cause rapid discharge and thus fires, and recycling is incredibly difficult due to the small length scales and multi-material composite nature of the devices. Many of these issues stem in part from the use of metal foils as current collectors. These materials are desirable because of their high conductivity. However, their weight and material properties result in these various challenges. The conductive polymer based current collector disclosed herein can be formed with volume conductive plastics comprising distributed conductive particles. The volume conductive plastics, however, have several advantageous properties (e.g., low density, plasticity and metastable conductivity) that can mitigate the above problems. Incorporation of these materials to function as current collectors requires a departure from standard battery assembly techniques, and new battery assembly techniques are set forth herein to facilitate the use of such volume conductive plastics to replace current metal current collectors.

To make a volume conductive plastic suitable for use as a current collector, additional accommodations are made. These accommodations include identifying a suitable resistivity range for the conductive polymer based current collector for a bipolar battery cell, ensuring that the polymer based current collector has good barrier properties for keeping the electrolyte from leaking out while also minimizing oxygen transfer into the cell, identifying a correct conductive particle loading to maintain a desired resistivity while additionally maintaining desired electric and mechanical properties (e.g., the conductive polymer based current collector becomes more insulating or less conductive when stretched, deformed, or broken).

Accordingly, a battery cell in accordance with various embodiments includes a battery electrode and a conductive polymer based current collector located on the battery electrode comprised of a conductive polymer layer. The conductive polymer layer is conductive in the thickness direction between an outer surface of the polymer based current collector and the battery electrode during normal battery operation of the battery cell. The polymer can be an inherently conductive polymer, or a polymer composite formed from an insulating polymer material and conductive particles. The conductive polymer based current collector is configured to become less conductive at least in the thickness direction when at least one of heated beyond a melting point associated with the conductive polymer based current collector or stretched beyond a yield point of the conductive polymer based current collector. In these events, the conductive network becomes at least locally disrupted to prevent rapid discharge of the battery cell and the thermal events that may result from a rapid discharge and based current collector.

The polymer based current collector, in one embodiment, includes a conductive polymer layer and at least one additional material layer. The polymer layer is a conductive support layer and the at least one additional material layer includes a conductive permeability prevention layer configured to at least limit water vapor transfer and oxygen transfer into the battery cell. The conductive permeability prevention layer, in one embodiment, is a different conductive polymer material (e.g., EVA, PVOH, PVDC, etc.) relative to the conductive support layer between 10 to 50 μm in thickness. The conductive permeability prevention layer, in one embodiment, may also be a thin layer of metal between 20 to 80 nm in thickness.

The at least one additional material layer may additionally include a conductive inner electrode adhesion layer configured to facilitate adhesion between the battery electrode and the conductive support layer.

The conductive support layer, in various embodiments, is a polymer composite material comprising an insulative polymer material and conductive particles in an amount sufficient to render the polymer composite material conductive in the thickness direction between the polymer based current collector and the battery electrode during normal battery operation of the battery cell.

Additionally, current recycling techniques for lithium-ion battery cells suffer from a variety of problems. Constructing a battery with polymer current collectors, on the other hand, enables alternative methods of disassembly/delamination that may significantly decrease the associated labor costs, especially when compared with currently used pyrometallurgical separation and hydrometallurgical separation techniques. Because polymers melt at temperatures well below currently used metallurgical processing (100-200° C. as opposed to 400-1500° C.), energy requirements can be significantly reduced. Additionally at these temperatures, any inorganic components will remain largely intact and potentially reclaimable, requiring no reducing agents, acids, or other chemical treatments to return the metals to their respective elementally pure feedstocks when metal foils are used as current collectors.

Accordingly, the present disclosure is directed to constructing a secondary/rechargeable battery cell, in particular a cell for a bipolar battery using conductive polymers as current collectors. The term “conductive polymer” as used herein can mean composite conductive polymers, i.e. polymer composite material comprising insulative polymers and conductive fillers, such as insulative polymers loaded with conductive carbon, or intrinsically conductive polymers (e.g., organic polymers that conduct electricity). Similarly, the term “polymer based current collector,” “conductive polymer current collector”, “conductive polymeric current collector” or simply “polymer current collector”, “organic polymer current collector”, “organic current collector”, volume-conducting plastic materials, and volume conductive plastics as used herein can mean composite conductive polymer current collectors, using insulative polymers loaded with conductive fillers (such as carbon), or intrinsically conductive polymer current collectors, using organic polymers that conduct electricity without the need for conductive fillers.

The term “volume conductive” here is used to specify films that conduct through the bulk structure of the film, as opposed to many other conductive films/sheets/substrates which have conductive coatings or patterns (ITO, aluminum, silver, copper, etc.) applied to the surface, while the bulk structure remains insulating. Solely for purposes of discussion, the following discussion will primarily refer to carbon-loaded polymer current collectors (e.g., composite conductive polymer current collectors) as an example for the present disclosure. It is also noted that other conductive particles (such as graphene, CNTs, copper, aluminum, nickel, silver, and metal coated beads or spheres) could be used to fill the composite conductive polymer films as well. In any case, filling an insulative polymer film with conductive particles converts such films from being essentially insulators into being at least moderately conductive (for example, operating in a metastable percolation threshold zone, as discussed herein), especially in a thickness direction extending from the top to the bottom of the film. However, as also noted above, the present disclosure could be practiced using intrinsically conductive polymers as well, without the need for adding conductive fillers such as carbon. In this case, the intrinsically conductive polymers could be doped, if desired, to achieve the preferred low resistivity during operation, while still becoming sufficiently insulative during melting caused by short-circuit current flow to cutoff the excessive current flow in melted areas created by the excessive current flow during the short circuit.

The use of a polymer based current collector allows cells, in one embodiment, to be constructed/assembled using no sealant or adhesive since the polymer current collectors can be thermally fused via pressure-assisted heat sealing or laser welding. Additionally, as noted above, the polymer current collectors disclosed herein display an interesting and highly useful behavior that, when heated close to the melting point, they substantially lose their conductivity, even becoming completely insulating. This loss of conductivity can be localized to only heat affected or melted regions of the polymer current collectors, and permits construction of cells that are highly resistant to short-related thermal runaway. Specifically, when a short-circuit occurs, increased current from the short-circuit will occur leading to creating heat affected or melted areas at points of the polymer where the current increases. This localized heating or melting will cause the polymer current collector to become irreversibly non-conductive at the affected area, thereby disrupting excess current flow caused by the short-circuit. This feature, with the higher sheet resistance of an engineered polymer based current collector compared to conventional metal current collectors, prevents the rapid discharge of the energy of the cell, thereby limiting thermal events.

To this end, in an implementation of the present disclosure a polymer based current collector can be composed of an insulative polymer infilled with conductive carbon (or other conductive material), preferably to achieve measured sheet resistances at thicknesses in a range of 1 to 50 μm between 0.1 kΩ and 1000 kΩ. The polymer can be any flexible engineering polymer, for example polyethylene terephthalate, polyurethane, or polyethylene, polyvinyldichloride, poly (ethylene vinyl acetate), poly (ethylene acrylic acid), or similar materials. As a test of the above feature of the change in conductivity in melted regions of the polymer current collector during development of the present techniques, sealing or welding was performed by placing two sheets of the carbon-filled composite conductive polymer in contact, and using a vacuum bag sealer or pouch sealer to heat up a selected area of the system and fuse the sheets under pressure. A digital version of the process would involve laser welding two sheets of conductive polymer around the outer edges (or any interior cavities) of a patterned cell.

After heat-pressing a melted line across the two joined conductive polymer films, the observed resistance increases by a factor of 30×, and cannot be measured. If the multimeter probes are placed on the melted area, resistance is unmeasurably high, and the same is true if probes are placed on either side of the melted region. This established that the melted regions of the conductive polymer film become less conductive or non-conductive. Unmelted areas immediately adjacent to (and even in-between) the melted regions, on the other hand, still show measurable resistance, indicating that conduction is still possible within these regions. This resistance increase is also observed in areas of the conductive polymer films which are subject to mechanical deformation. In other words, if a conductive polymer film is deformed past the yield point, the resistance in the deformed areas is greatly increased. For example, the resistance in such deformed areas can increase by a factor of 1000× at a strain of 100%.

In accordance with another aspect of the present disclosure, a method is provided of attaching electrode films (e.g., cathode or anode electrodes) to a conductive polymer film (for example, polyethylene loaded with conductive carbon particles) with or without use of an additional surface coating of conductive additives or secondary adhesion films, such as a primer layer. The pre-patterned cathode or anode electrodes can be attached to the conductive polymer film through bonding with a calendering step. If desired, the calendering step can be performed at room temperature (e.g., approximately between 20° C.-25° C.). However, the laminate can be passed through the calendaring system at an elevated temperature, e.g. at a temperature between 10° C. above a glass transition temperature of the conductive polymeric current collector and up to 10° C. above a melting temperature of the conductive polymeric current collector, if desired.

After adhesion using the above-described calendering operation (or an alternative pressure applying operation), the electrodes are difficult to physically dislodge from the current collector and show a 10-fold decrease in resistance when measured across the backside of the combined films, indicating good electrical contact between the current collector and the electrode. Notwithstanding that an excellent bond can be achieved in this manner between the current collector and the electrode, adhesive can be added in the stack being calendered, if desired, to further strengthen the bond.

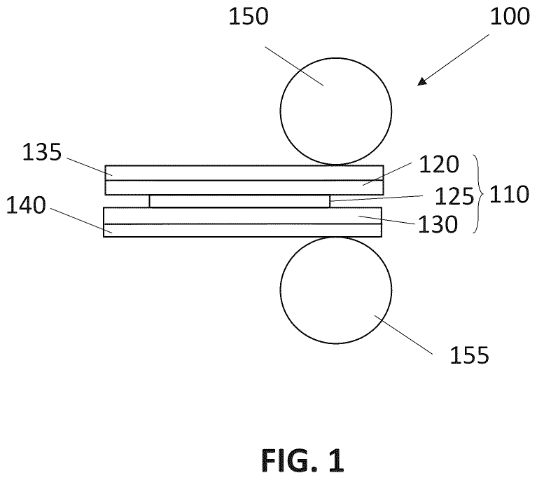

Referring to FIG. 1 as an example of the above-discussed calendering operation, in one implementation of this disclosure a cathode film 125 was placed between two supporting sheets of mylar 130 and then cut to various shapes by a cutting method, such as a laser cutting (e.g. with a 1064 nm Nd: YAG laser in a Keyence laser marking system). One sheet of mylar 130 was removed, and the open face of the cathode 125 was placed in direct contact with a sheet of conductive polymer current collector 120. The stack 110 of these three materials (e.g., current collector 120, cathode 125, mylar 130) was then placed between an upper metal sheet 135 and a lower metal sheet 140 and fed into a calendering system 100 at approximately 3000 psi (although larger pressures could be used, if desired, up to, for example, 30,000 psi). The upper metal sheet 135 and a lower metal sheet 140 serve to protect the stack 110 from direct contact with the calendering rollers 150 and 155 and to spread the pressure on the stack 110 from the calendering rollers. After calendering, the remaining single sheet of mylar 130 was peeled off the cathode 125 either mechanically or by hand, leaving the polymer current collector 120 firmly adhered to the cathode electrode 125.

The present disclosure is not limited to adhering a current collector to a cathode, and alternative methods for direct adhesion also involve use of anode films as anode electrodes, e.g., graphite, for adhering an anode current collector thereto. Whether adhering a polymer current collector to a cathode or an anode, heat may or may not be applied, if desired, in the adhering processes. Also, multiple pressures could be used during the calendering operation. Films with a range of sheet resistances from 0.1 KΩ to 1 MΩ can be used for the polymer current collectors. Other laser types or cutting methods could be used for film cutting to prepare the stack 110 (or an equivalent stack 110 for adhering a current collector to an anode electrode), and adhesion between the layers of the stack 110 could be promoted through other means, such as use of adhesives in supplement to the use of pressure from the calendering rollers. Further, although the example shown in FIG. 1 pertains to the use of calendering rollers 150 and 155, other forms of applying pressure to the stack 110 could be used, such as a hydraulic press (not shown).

As discussed above, the implementations of the present disclosure replace currently used metallic foil current collectors with volume-conducting plastic materials. This significantly improves the gravimetric energy density of the battery cells through, for example, a 9-fold reduction in the density of the anode foil and an approximately 3-fold reduction in the density of the cathode foil. The implementations of the present disclosure are compatible with multiple anode and cathode chemistries, including lithium metal, graphite, silicon-graphite, LCO, NCA, NMC, LFP, etc., but is also extensible to any battery system using ionic charge carriers (Na⁺, Mg²⁺, etc.). In this regard, compatibility and functionality of the polymer current collectors described herein as supports for active battery materials have been demonstrated on the coin cell level, and capacity and cycle life were similar to battery cells constructed with metal foil current collectors.

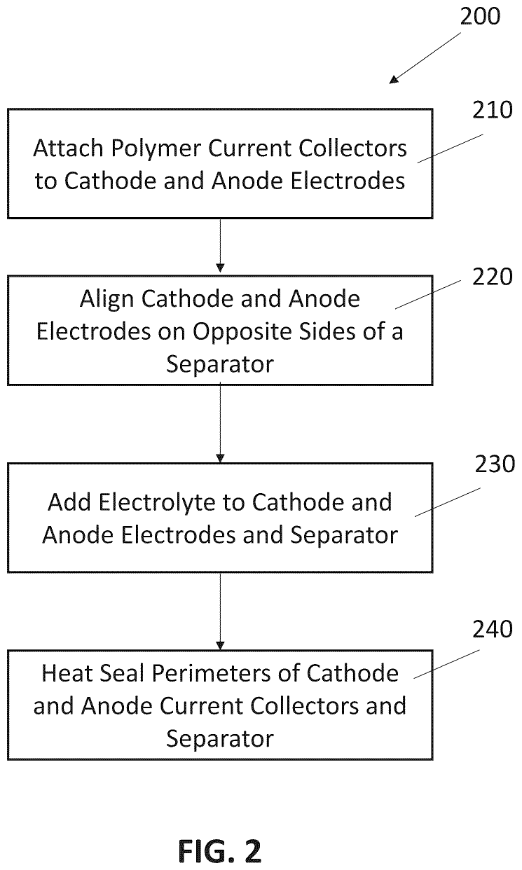

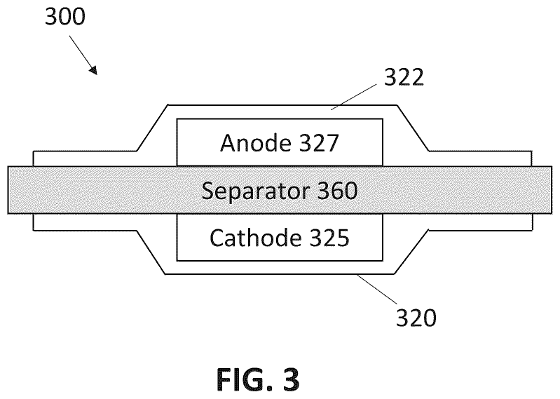

FIG. 2 shows a flowchart of an assembly operation 200 for manufacturing a battery cell, in accordance with aspects of the present disclosure. FIG. 3 shows an example of a battery cell 300 assembled by the method shown in FIG. 2, in accordance with aspects of the present disclosure. Using the current collector/electrode adhering techniques described above with reference to FIG. 1, a cathode electrode 325 and an anode electrode 327 are respectively attached to polymer based current collectors 320 and 322 in step 210. For purposes of example, the anode electrode 327 can be graphite and the cathode electrode 325 can be nickel-manganese-cobalt (NMC). Next, in step 220, the cathode and anode electrodes 325 and 327 were aligned on either side of a separator film 360. Separator 360 can be a polymeric membrane, examples including Celgard™ separator membranes. If desirable, additional scaling material such as a thermoplastic or thermoset polymer, may be added on either side or both sides of the separator in the region to be sealed in subsequent sealing operation. Electrolyte was added to the cathode and anode electrodes 325 and 327 and the separator 360 in step 230. Then, in step 240, the cell 300 was heat-sealed with a heated laboratory press on each edge of the cell (specifically at the edges of the current collectors 320 and 322 and the edges of the separator 360) at 180° C. If desired, the heat sealing operation can be performed at any temperature in a preferred range of 110-200° C. depending on whether it is desirable to melt the separator 360 around the perimeter of the sealed package 300 or leave it intact. Alternatively, the electrolyte adding step 230 may be performed after the heat sealing step 240 through an electrolyte filling port and the filling port is sealed once the addition of the electrolyte to the cell is completed. This port may be pre-engineered into the system, or directly generated using a hypodermic needle (or similar device). The port may be rescaled through a variety of techniques-addition of a pressure-sensitive adhesive tape (e.g. Kapton), heat seal using a “patch” of the current collector affixed via impulse sealing or laser welding, addition of a curable sealant (e.g. silicone or other chemically-resistant watertight seal), or addition of an EVA-based hot-melt adhesive or formulations/blends thereof (e.g. BEVA 371).

Selection of the separator material for the separator 360 is important to this process since separator membranes with exterior ceramic layers (e.g., Al₂O₃) or surfactant treatments will not function well in systems implemented using the present disclosure since they result in delamination of the current collectors in the seal zone. On the other hand, multilayer separators, or any separator containing a low-melting point polymer on the interior, are preferred for implementations using the present disclosure. For example, as noted above, temperature in the range of 110-200° C. is preferred, depending on whether it is desirable to melt the separator 360 around the perimeter of the sealed package 300 or leave it intact.

Additionally, as shown in FIG. 3, an outer edge of the separator 360 should extend beyond the perimeters of the polymeric current collectors 320 and 322 adhered to the cathode and anode electrodes 325 and 327. Otherwise, the cell 300 is likely to gradually self-discharge (for example, over the course of 6-24 hours).

Once the cell 300 is sealed, it can be placed in a testing fixture (not shown) for formation and cycling. This testing fixture must be different than typical cells (i.e., those using metallic current collectors) because the polymer current collectors such as 320 and 322 described herein have poor conduction in the lateral (XY) direction resulting from its high sheet resistivity (in other words, these polymer current collectors are thin films that rely on conductivity in the Z directions between the top surface and the bottom surface of these films). Therefore, electrical contact must be made across the entire electrode area of the cell 300 to provide the shortest possible path from terminal to electrode material. In one implementation, this takes the form of a conductivity enhancing metal foils (not shown) placed upon each side of the cell 300, over the polymer based current collectors 320 and 322, respectively, such that the conductivity enhancing metal foils are separated from the cathode and anode electrodes 325 and 327 by the polymer based current collectors 320 and 322. Alternative implementations include a conductive paint consisting of metal or carbon particles to cover the polymer based current collectors 320 and 322. If a series connected or bipolar stack of cells is provided (each made up of a sub-cell 300 shown in FIG. 3) this conductivity enhancement using either enhancing metal foils, conductive paint, etc., can be implemented only on the top and bottom sub-cells of a cell stack, or can be implemented for each of the sub-cells.

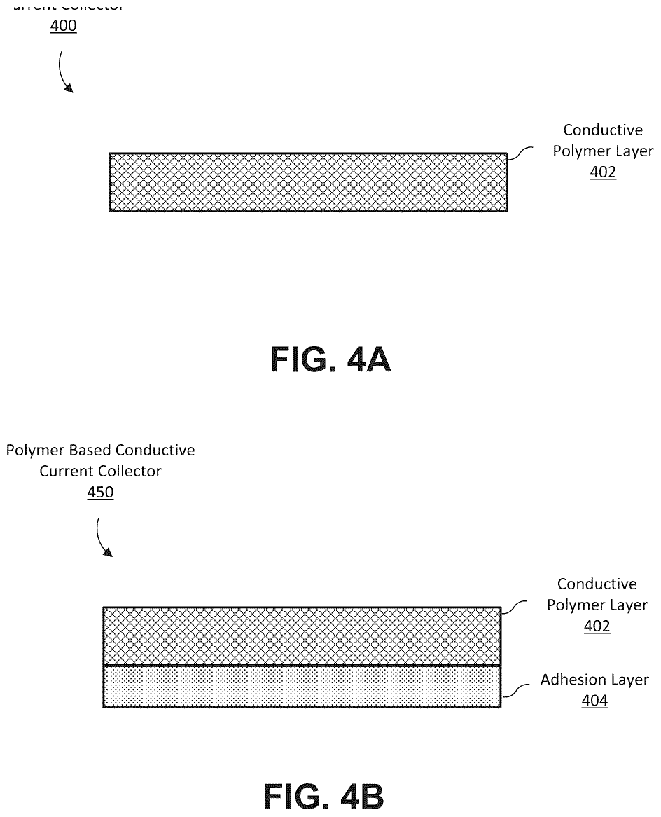

FIGS. 4A-4B show a polymer based current collector 400, in accordance with one or more embodiments of the present disclosure. FIG. 4A shows polymer based conductive current collector 400, in accordance with various embodiments. In this example, polymer based conductive current collector 400 is formed of a single conductive polymer layer 402. In one embodiment, the single conductive polymer layer 402 may be a single layer of polymer with a low water vapor transport rate (WVTR) and oxygen transport rate (OTR) (e.g. PVDC or other polymers with similarly low WVTR and OTR) and conductive particles in an amount sufficient to render the polymer conductive in the thickness direction. In this context low WVTR and OTR are polymers where 1 mil (25 microns) of the material has a WVTR and OTR of <5 gm/100 square inch/24 hours and 5 cc/100 square inch/24 hours respectively. Accordingly, in one embodiment, conductive current collector 400 is fixed directly to the battery electrode (e.g., anode 327 and/or cathode 325 of FIG. 3) and, in a bipolar cell configuration, conductive current collector 400 is fixed directly to the anode of a first sub cell and to the cathode of a second sub cell.

Similarly, FIG. 4B shows polymer based conductive current collector 450, in accordance with various embodiments. In this example, polymer based conductive current collector 450 is formed of a single conductive polymer layer 402 and an adhesion layer 404. Accordingly, in one embodiment, the adhesion layer 404 fixes to the battery electrode (e.g., anode 327 and/or cathode 325 of FIG. 3) to the single conductive polymer layer 402 and, in a bipolar cell configuration, adhesion layer 404 is on either side of the conductive current collector 400 fixing the anode of a first sub cell on one side of conductive current collector 400 and the cathode of a second sub cell on the other.

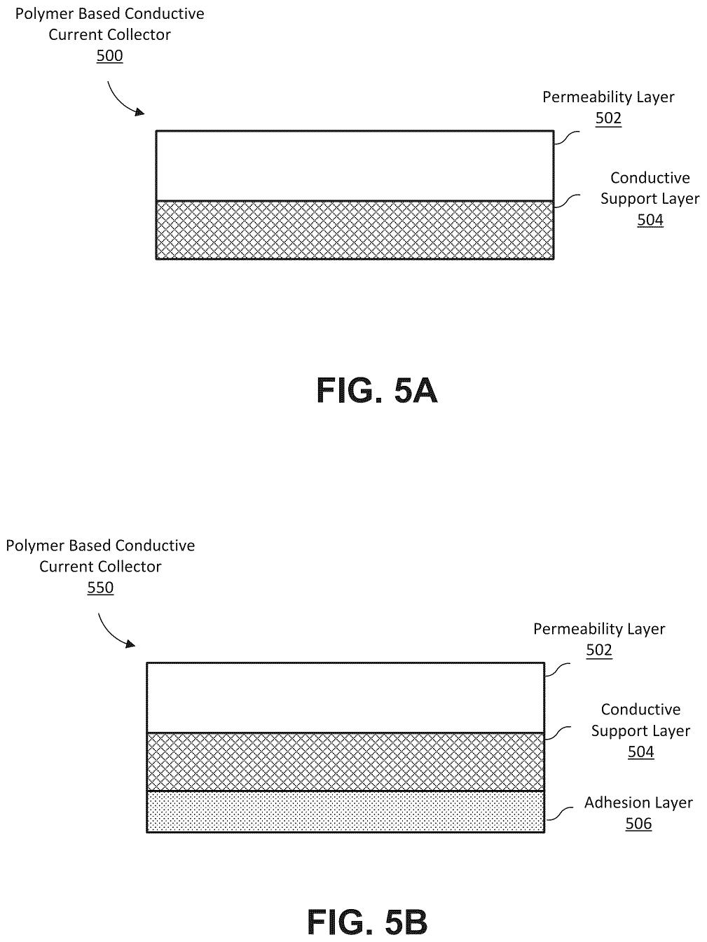

FIGS. 5A-5B show a multilayer polymer based conductive current collector, in accordance with one or more embodiments of the present disclosure. FIG. 5A shows polymer based conductive current collector 500, in accordance with various embodiments. In this example, polymer based conductive current collector 500 is a multilayer conductive polymer formed of a conductive support layer 504 and a permeability layer 502. The conductive permeability layer 502 is on a surface of the conductive support layer 504 and is configured to at least limit water vapor transfer and oxygen transfer into the battery cell, as elaborated elsewhere herein. The permeability layer 502, in one embodiment, is a different conductive polymer material (e.g., EVA, PVOH, PVDC, etc.) relative to the conductive support layer 504 between 10 to 50 μm in thickness. The conductive support layer 504 can be selected from the polyolefin group or similar polymers.

Accordingly, in one embodiment, conductive current collector 500 is fixed directly to the battery electrode (e.g., anode 327 and/or cathode 325 of FIG. 3). In a bipolar cell configuration, two conductive support layers 504 sandwich a single permeability layer 502 so that the anode of a first sub cell and the cathode of a second sub cell are each directly fixed to their own conductive support layers 504 while each share a single permeability layer 502 therebetween.

Similarly, FIG. 5B shows polymer based conductive current collector 550, in accordance with various embodiments. In this example, polymer based conductive current collector 550 is a multilayer conductive polymer formed of a conductive support layer 504, a permeability layer 502, and an adhesion layer 506. Accordingly, in one embodiment, the adhesion layer 506 fixes to the battery electrode (e.g., anode 327 and/or cathode 325 of FIG. 3) to the conductive support layer 504. In a bipolar cell configuration, two conductive support layers 504 sandwich a single permeability layer 502, as described above. In this embodiment, this stack is further sandwiched by an adhesion layer 506 on the electrode side of each conductive support layers 504 so that the anode of a first sub cell and the cathode of a second sub cell are each directly fixed to their own conductive support layers 504 via an adhesion layer 506 while again, each share a single permeability layer 502 therebetween. While FIG. 5A-5B show permeability layer 502 on an outer surface of conductive support layer 504, permeability layer 502 could be located on the inner (or electrode facing) surface of conductive support layer 504.

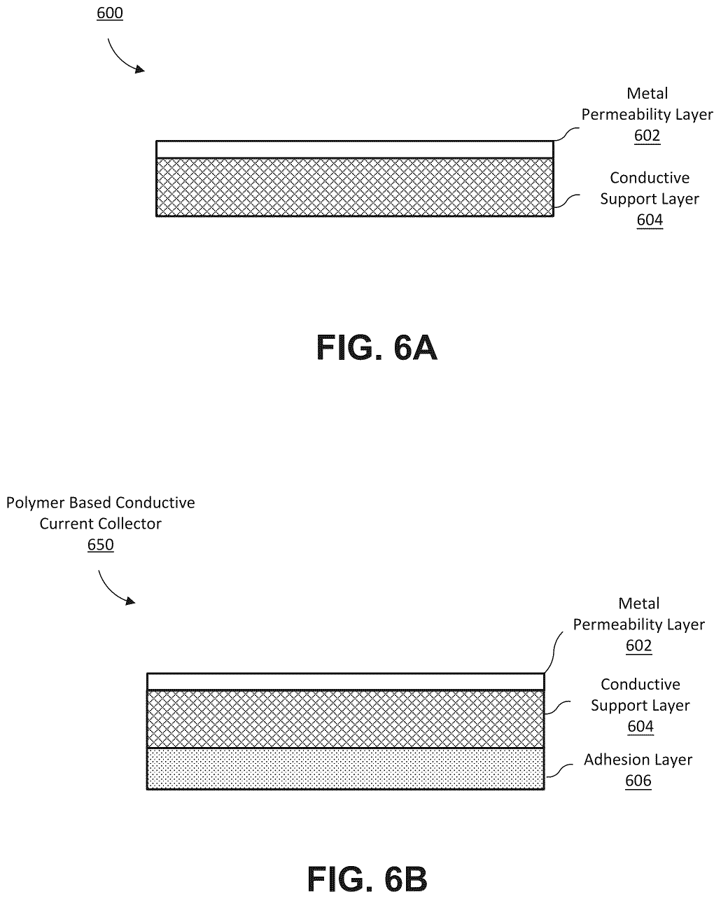

FIGS. 6A-6B show another multilayer polymer based current collector, in accordance with one or more embodiments of the present disclosure. FIG. 6A shows polymer based conductive current collector 600, in accordance with various embodiments. In this example, polymer based conductive current collector 600 is a multilayer conductive polymer formed of a conductive support layer 604 and a metal permeability layer 602. The metal permeability layer 602 is on the surface of the conductive support layer 604 and is also chosen for its barrier properties in limiting water vapor transfer and oxygen transfer into the battery cell. Metal permeability layer 602 may be a thin layer of metal between 20 to 80 nm in thickness but may be as thick as 1 um. The upper limit on metal thickness of metal permeability layer 602, in one embodiment, is a function of when metal permeability layer 602 becomes too conductive laterally to afford the desired safety features. The metal thickness, in one embodiment, is less than where the sheet resistance of the metal layer is substantially less than the electrode sheet resistance to which it is attached. For example, if the sheet resistance of the cathode or anode is 200 Ohms/square, the sheet resistance of the metal layer is chosen to be greater than this value or at least not less than 20% of the electrode layer. The precise upper limit to the thickness of the metal layer will depend on the resistivity of the metal and the sheet resistance of the electrode.

Accordingly, in one embodiment, conductive current collector 600 is fixed directly to the battery electrode (e.g., anode 327 and/or cathode 325 of FIG. 3). In a bipolar cell configuration, two conductive support layers 604 sandwich a single metal permeability layer 602 so that the anode of a first sub cell and the cathode of a second sub cell are each directly fixed to their own conductive support layers 604 while each share a single metal permeability layer 602 therebetween.

Similarly, FIG. 6B shows polymer based conductive current collector 650, in accordance with various embodiments. In this example, polymer based conductive current collector 650 is a multilayer conductive polymer formed of a conductive support layer 604, a metal permeability layer 602, and an adhesion layer 606. Accordingly, in one embodiment, the adhesion layer 606 fixes to the battery electrode (e.g., anode 327 and/or cathode 325 of FIG. 3) to the conductive support layer 604. In a bipolar cell configuration, two conductive support layers 604 sandwich a single metal permeability layer 602, as described above. In this embodiment, this stack is further sandwiched by an adhesion layer 606 on the electrode side of each conductive support layers 604 so that the anode of a first sub cell and the cathode of a second sub cell are each directly fixed to their own conductive support layers 604 via an adhesion layer 606 while again, each share a single metal permeability layer 02 therebetween. While FIG. 6A-6B show metal permeability layer 602 on an outer surface of conductive support layer 604, metal permeability layer 602 could be located on the inner (or electrode facing) surface of conductive support layer 604.

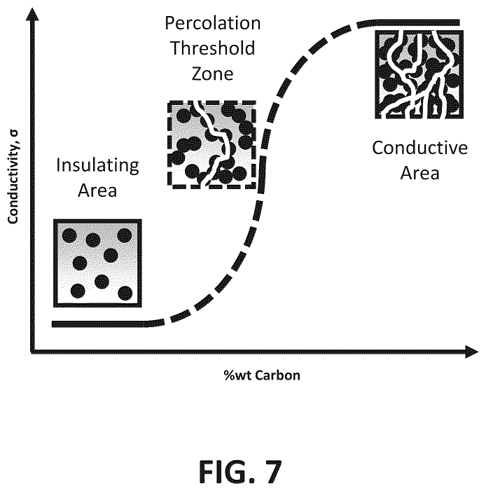

FIG. 7 shows a graph of the variation of electrical conductivity of a carbon-loaded composite conducting polymer sheet as a function of filler content (e.g., the amount of carbon) added to a base polymer that is insulative (for example, low-density polyethylene, commonly referred to as LDPE). As shown in FIG. 7, depending on the amount of carbon added, the LDPE polymer-carbon composite can be either insulative (in the insulating area of light carbon filler content on the left side of the graph), highly conductive (in the conductive area of high carbon filler content on the right side of the graph where the polymer sheet will have a steady high conductivity), or metastable in a percolation threshold zone (PTZ) or a metastable region located between the insulating area (at 0% conductivity) and the conductive area (where the LDPE polymer-carbon composite gradually increases in conductivity as the amount of carbon filler therein increases). It is noted that, in the conductive area, a steady level of high conduction exists which remains steady once this high conduction level is reached even if additional carbon is added.

In the implementations discussed above, the amount of carbon filler added to the LDPE (or other polymer used for the current collector film) is preferably set so that the conductive polymer current collectors 320 and 322 adhered to the cathode and anode electrodes 325 and 327, respectively, operate in the metastable percolation threshold zone (PZT) shown in FIG. 4. In particular, in accordance with implementations of the present disclosure, amounts of conductive particles, such as carbon, in the insulative polymer base material (such as LDPE) of the conductive polymeric current collector are sufficient (i.e., enough of the conductive particles are provided) to cause the composite material to conduct electrons in a 1%-90% range of the percolation threshold zone between the insulating area and the steady conductive area.

In further implementations, amounts of conductive particles, such as carbon, in the insulative polymer base material (such as LDPE) of the conductive polymeric current collector are sufficient to cause the composite material to conduct electrons in a preferred area of 5%-50% range of the PTZ (although the PZT can extend up to 90% conductivity) between the insulating area (where an insufficient amount of particles are provided to allow conduction of electrons, i.e., not enough conductive particles are provided to the polymer to allow conduction of electrons) and the steady conductive area (where enough conductive particles are provide to allow for a steady conduction of electrons that will not increase, even if additional conductive particles are added to the insulative polymeric material). Alternatively, the amount of carbon added to the LDPE can be sufficient for the polymer composite to be in the conductive area, if desired. However, in order to take advantage of the feature of quickly changing the conductivity of the polymer current collectors to be more insulative in areas which melt due to short circuit currents, it has been found to be preferable to keep the conductivity of the polymer current collectors in the metastable percolation threshold region shown in FIG. 7.

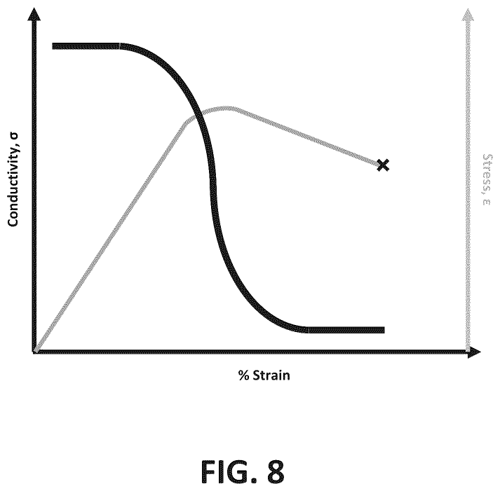

FIG. 8 shows a graph of the effects of deformation on the electrical conductivity of conductive polymer current collectors as a function of strain. In particular, as shown in FIG. 8, as the amount of strain on a conductive polymer current collector increases, the conductivity of the conductive polymer current collector decreases. This is useful in situations where the polymer current collector is deformed from physical abuse, such as puncture and nail penetration.

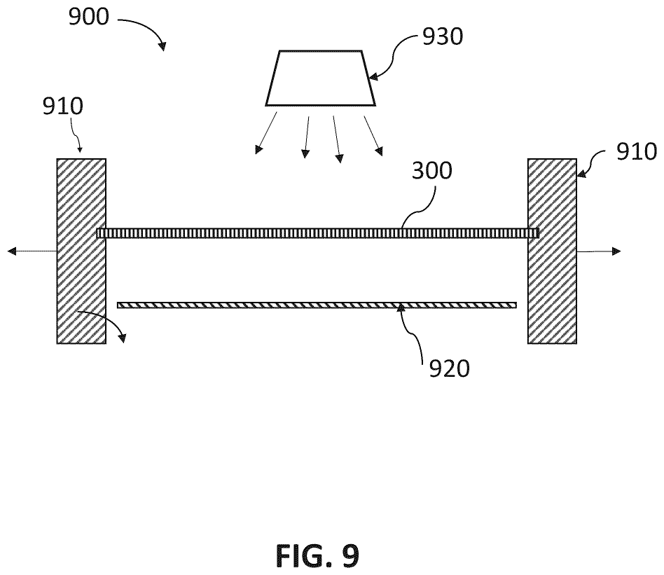

As shown in FIG. 9, stretching a battery cell 300 which includes the polymer current collectors leads to a reasonably controllable delamination for recycling of the battery cell materials, for example 95% removal of cathode electrode from the cathode current collector with only stretching of the battery cell 300 using a pair of clamps 910 to stretch the battery cell 300 in opposite directions.

FIG. 9 shows a delaminating apparatus 900 to provide controllable delamination of the battery cell 300 constructed with conductive polymer current collectors in accordance with the implementations discussed above, for purposes of recycling the materials of the battery cell 300. In combination with stretching using the clamps 910, the battery cell 300 can be placed in a heated environment (e.g., 180° C.) provided by a heater 920 which causes significant warping and separation of the layers of the battery cell (e.g., the polymer current collectors, the cathode electrode, the anode electrode and the separator). Vapor treatments or other condensation treatments could also be leveraged to induce thermal strain in the systems using a condensation apparatus 930. Solvents could also be used, noting that organic polymer current collectors constructed with materials such as polyethylene are readily soluble in solvents such as n-hexane, while the active materials are not. With a combination of some or all of these techniques (i.e., placing a cell or stack of cells between clamps to provide a controlled pull while under heating and condensation), the active materials can be isolated from the battery and readily recovered. For example, the controlled pull can be between 10 mm/min and 5m/min. While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Unless otherwise stated, all measurements, values, ratings, positions, magnitudes, sizes, and other specifications that are set forth in this specification are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A battery cell comprising:
a battery electrode; and
a conductive polymer based current collector located on the battery electrode comprising a conductive polymer layer,
wherein the polymer based current collector is conductive in a thickness direction between the polymer based current collector and the battery electrode during normal battery operation of the battery cell, and
wherein the conductive polymer based current collector is configured to become less conductive at least in the thickness direction when at least one of heated beyond a melting point associated with the conductive polymer based current collector or stretched beyond a yield point of the conductive polymer based current collector.

2. The battery cell of claim 1, wherein the polymer based current collector includes the conductive polymer layer and at least one additional material layer, the polymer layer is a conductive support layer and the at least one additional material layer includes a conductive permeability prevention layer on the conductive polymer layer configured to at least limit water vapor and oxygen transfer into the battery cell.

3. The battery cell of claim 2, wherein the at least one additional material layer further includes a conductive inner electrode adhesion layer configured to facilitate adhesion between the battery electrode and the conductive support layer.

4. The battery cell of claim 2, wherein the conductive support layer is a polymer composite material comprising an insulative polymer material and conductive particles in an amount sufficient to render the polymer composite material conductive in the thickness direction between the polymer based current collector and the battery electrode during normal battery operation of the battery cell.

5. The battery cell of claim 4, wherein the conductive particles comprise a range of 20-50% wt carbon.

6. The battery cell of claim 2, wherein the conductive permeability prevention layer is a different conductive polymer material relative to the conductive support layer between 10 to 50 μm in thickness selected from the group consisting of: EVA, PVOH, and PVDC.

7. The battery cell of claim 6, wherein the conductive polymer based current collector is formed using blown film extrusion.

8. The battery cell of claim 2, wherein the conductive permeability prevention layer is a layer of metal between 20 to 80 nm in thickness.

9. The battery cell of claim 8, wherein the conductive polymer based current collector is formed using a vapor deposition process selected from the group consisting of: physical vapor deposition and chemical vapor deposition.

10. The battery cell of claim 1, wherein the conductive polymer layer is a single layer of polymer and conductive particles in an amount sufficient to render the single layer of polymer conductive in the thickness direction, and the single layer of polymer has a low WVTR and OTR of <5 gm/100 square inch/24 hours and 5 cc/100 square inch/24 hours respectively for a 1 mil thick film.

11. The battery cell of claim 1, wherein the polymer based current collector has a measured sheet resistance, in a range of thickness between 1 to 100 μm, of between 0.1 kΩ and 1000 kΩ.

12. The battery cell of claim 1, wherein the polymer based current collector is configured to become insulating in the thickness direction when the polymer based current collector is elongated past the yield point of the polymer.

13. The battery cell of claim 1, wherein the battery electrode is a cathode electrode or an anode electrode of the battery cell.

14. A conductive polymer based current collector for a battery cell comprising:
a conductive polymer layer that is conductive in a thickness direction during normal battery operation of the battery cell,
wherein the conductive polymer layer is configured to become less conductive at least in the thickness direction when at least one of heated beyond a melting point associated with the conductive polymer layer or stretched beyond a yield point of the conductive polymer based current collector.

15. The conductive polymer based current collector of claim 14, further comprising:
at least one additional material layer, wherein the conductive polymer layer is a conductive support layer and the at least one additional material layer includes a conductive permeability prevention layer on the conductive polymer layer configured to at least limit water vapor and oxygen transfer into the battery cell.

16. The conductive polymer based current collector of claim 15, further comprising:
a conductive inner electrode adhesion layer configured to facilitate adhesion between a battery electrode and the conductive polymer based current collector.

17. The conductive polymer based current collector of claim 15, wherein the conductive support layer is a polymer composite material comprising an insulative polymer material and conductive particles in an amount sufficient to render the polymer composite material conductive in the thickness direction between the polymer based current collector and a battery electrode during normal battery operation of the battery cell.

18. The conductive polymer based current collector of claim 17, wherein the conductive particles comprise a range of 20-50% wt carbon.

19. The conductive polymer based current collector of claim 15, wherein the conductive permeability prevention layer is a different conductive polymer material relative to the conductive support layer between 10 to 50 μm in thickness selected from the group consisting of: EVA, PVOH, and PVDC.

20. The conductive polymer based current collector of claim 15, wherein the conductive permeability prevention layer is a layer of metal between 20 to 80 nm in thickness.
